(19) United States
(12) Patent Application Publication
(10) Pub. No.: US 2017/0201137 A1
(43) Pub. Date: Jul. 13, 2017

(54) Utilization of Magnetic Fields in Electric Machines

(71) Applicant: Ford Global Technologies, LLC, Dearborn, MI (US)

(72) Inventors: Feng Liang, Troy, MI (US); Franco Leonardi, Dearborn Heights, MI (US); Michael W. Degner, Novi, MI (US)

(21) Appl. No.: 14/994,359

(22) Filed: Jan. 13, 2016

(51) Int. Cl. H02K 1/27

(52) U.S. Cl. CPC H02K 1/276

(57) ABSTRACT

An electric machine may include a plurality of sections each having permanent magnets arranged therein to form magnetic poles. The laminations may be stacked to form a rotor. A stator may surround the rotor. A non-magnetically permeable layer may be interposed between at least one adjacent pair of the sections that has skewed magnetic poles.

### TECHNICAL FIELD

The present disclosure relates to magnetic field utilization for a rotor of an electric machine.

### BACKGROUND

Electric machines typically employ a rotor and stator to produce torque. Electric current flows through the stator windings to produce a magnetic field. The magnetic field generated by the stator may cooperate with permanent magnets on the rotor to generate torque.

### SUMMARY

An electric machine may include a plurality of laminations,. The laminations may be stacked to form a rotor. A stator may surround the rotor. The rotor laminations may be subdivided axially into sections each comprising permanent magnets arranged therein to create magnetic poles. The sections can be arranged so that the magnetic axis of the corresponding poles are not aligned, but skewed to obtained a smooth mechanical torque. A non-magnetically permeable layer may be interposed between at least one adjacent pair of the sections that has skewed magnetic poles.

The thickness of the layer may be based on an airgap distance between the rotor and stator. For example, the thickness may be more than twice the airgap distance between the rotor and stator. The thickness of the layer may be less than a multiple of four of an airgap distance between the rotor and stator. The layer may be composed of any material found to reduce a magnetic field. For example, the layer may be made of polytetrafluoroethylene.

### BRIEF DESCRIPTION OF THE DRAWINGS

FIG. 1A is a plan view of a rotor lamination;

FIG. 1B is a side view of the rotor section comprised of a stack of laminations for the electric machine shown in FIG. 1A;

FIG. 2A is a diagrammatic view of an electric machine with a rotor comprised of multiple poles, wherein flux lines are generated solely by a permanent magnet;

FIG. 2B is a diagrammatic view of an electric machine with a stator comprised of multiple energized windings, wherein the flux lines are generated solely by stator windings;

FIG. 3A is a perspective view of a machine rotor with a layer of matter with low magnetic permeability disposed between two skewed sections;

FIG. 3B is a perspective view of a pair of skewed, adjacent sections with a layer of matter with low magnetic permeability disposed on one of the sections;

FIG. 4 is a perspective view of a rotor with an ABBA configuration and a layer of matter between the AB sections; and

FIG. 5 is a chart depicting the increase in specific torque with respect to the thickness of a layer with low magnetic permeability.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Electric machines are characterized by an undesirable oscillation in the torque which is caused by harmonics present in the airgap flux and in the airgap permeance. Most electric machines, and in particular Permanent Magnet (PM) electric machines, are designed with rotor skew i.e. the laminations of active rotor material may be skewed, or staggered, along the axis of the rotor. Skewing may result in staggered permanent magnets and magnetic poles along the axis of the rotor. Skewed sections may cause an overall reduction in the average torque of the machine at all available speeds because the magnetic components are out of alignment, but skewing helps to minimize the harmonics, as discussed above.

For example, in the case of an 8-pole machine with two rotor sections, 48-slot stator, a typical skew angle is 3.75°. The skewing of the rotor is intended to produce a smoother mechanical torque than would otherwise be achieved using a rotor having aligned permanent magnets. Skewing may eliminate undesirable torque ripple caused by harmonics and many different skew angles may be used to achieve this result. Skew, however, does not contemplate two poles that are supposed to be aligned by design but because of manufacturing tolerances are not exactly aligned.

The average torque generated across all speeds of the electric machine may be reduced by skewing, in part, because magnetic field leakage may occur between skewed permanent magnets. This leakage may cause a small reduction in the available torque of the machine, and the leakage may not exist on non-skewed machines.

In addition, skewing may open a path for magnetic flux to leak from one lamination section to the adjacent one, without adding torque. Because magnetic fields generally follow the path of least resistance between opposite poles, the skewing and staggering of permanent magnets to reduce torque ripple may, consequently, cause additional magnetic flux leakage to occur. A section of the rotor may be comprised of one lamination or a plurality of laminations stacked together. The laminations of a section may be skewed relative to other laminations in the section or skewed collectively, relative to other sections of the rotor. This means a section of the rotor may be comprised of any number of laminations stacked together or a single block of composite material.

In order to maximize the magnetic field and resulting torque, the amount of active rotor material is typically maximized. Active rotor material may include a material capable of generating or carrying a magnetic or electric field. Maximization of this material, in theory, generates the most torque. Rotor materials with the highest magnetic permeability are chosen. An introduction of materials without high magnetic permeability would presumably decrease the torque generation of the electric machine because the rotor would have wasted space (i.e., material that does not generate torque). Materials with high magnetic permeability may be generally referred to as ferromagnetic or ferrimagnetic. Presumably, a rotor composed of entirely active rotor material would create a more effective magnetic field than a rotor composed of partially active rotor material.

The introduction of a magnetically reluctant layer or layers that is not active rotor material, unexpectedly increases the utilization of permanent magnets in the rotor and increases the torque output of the electric machine. For example, the introduction of a reluctant layer with a thickness twice that of the airgap thickness between the stator and rotor may provide a specific torque increase greater than 0.25%. This amount, while seemingly nominal, can justifiably decrease the cost of electric machines because the improved utilization of permanent magnets may allow the size of the permanent magnets to be reduced. The increase in specific torque of the electric machine may depend on the thickness of the layer relative to the airgap and the electric current flowing through the stator.

A reluctant layer with low magnetic permeability may be inserted between adjacent sections having skewed magnetic poles. The layer may have a solid, liquid, or gas phase. The layer may redirect the magnetic field of the permanent magnets to a more desirable course and reduce leakage between permanent magnets. The layer may be a diamagnetic or paramagnetic material (e.g., water, copper, bismuth, superconductors, wood, air, polytetrafluoroethylene, or vacuum). Many different types of matter are capable of obtaining similar results and may fall into these designations. Materials with low magnetic permeability may be able to reduce the field leakage between sections with skewed poles or redirect the field into a more desirable course. Properly directed magnetic flux paths may increase the generated torque of the machine.

Permanent magnets may have multiple orientations when disposed on or within the sections. For example, permanent magnets may be arranged in a V-shape position providing poles at each V. Permanent magnets may also be oriented such that one of the magnetic poles is directed radially outward. The orientation and position of the magnets may have a direct effect on the electric machine's efficiency, and any skewed orientation or position may cause magnetic field leakage between the permanent magnets.

The poles of the permanent magnets may individually or cooperatively form magnetic poles of the rotor. Many rotors have a plurality of permanent magnets arranged to cooperate with the stator' s magnetic field in order to generate torque. The poles may be generated using permanent magnets, induced fields, excited coils, or a combination thereof.

Laminations are generally made of materials with high magnetic permeability. This high magnetic permeability allows magnetic flux to flow through the laminations without losing strength. Materials with high magnetic permeability may include iron, electrical steel, ferrite, or many other alloys. Rotors with laminations may also support an electrically conductive cage or winding to create an induced magnetic field. A rotor having four laminations or sections of laminations may have the sections configured in an ABBA orientation. The ABBA orientation means that the “A” sections are skewed to the same degree relative to the “B” sections. The rotor may have other lamination configurations (e.g., ABC or ABAB).

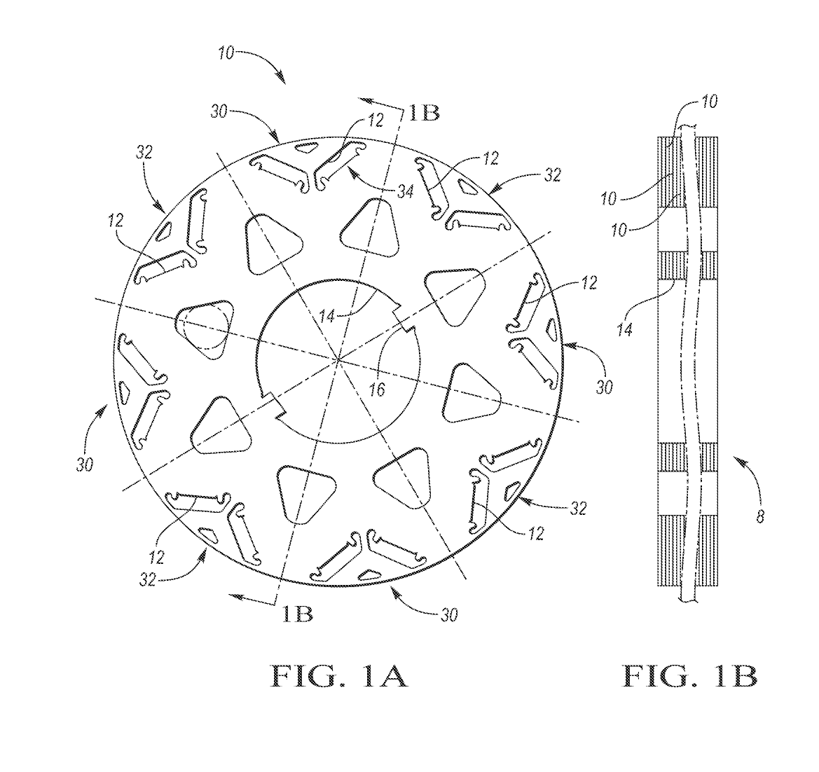

Referring now to FIG. 1A, a section 10 for a rotor is shown. The section 10 may define a plurality of pockets or cavities 12 adapted to hold permanent magnets. The center of the section 10 may define a circular central opening 14 for accommodating a driveshaft with a keyway 16 that may receive a drive key (not shown). The cavities may be oriented such that the permanent magnets (not shown) housed in the pockets or cavities 12 form eight alternating magnetic poles 30, 32. It is well known in the art that an electric machine may have various numbers of poles. The magnetic poles 30 may be configured to be north poles. The magnetic poles 32 may be configured to be south poles. The permanent magnets may also be arranged with different patterns. As shown in FIG. 1A, the pockets or cavities 12, which hold permanent magnets, are arranged with a V-shape 34. Referring now to FIG. 1B, a plurality of sections 10 may form a rotor 8. The rotor has a circular central opening 14 for accommodating a driveshaft (not shown).

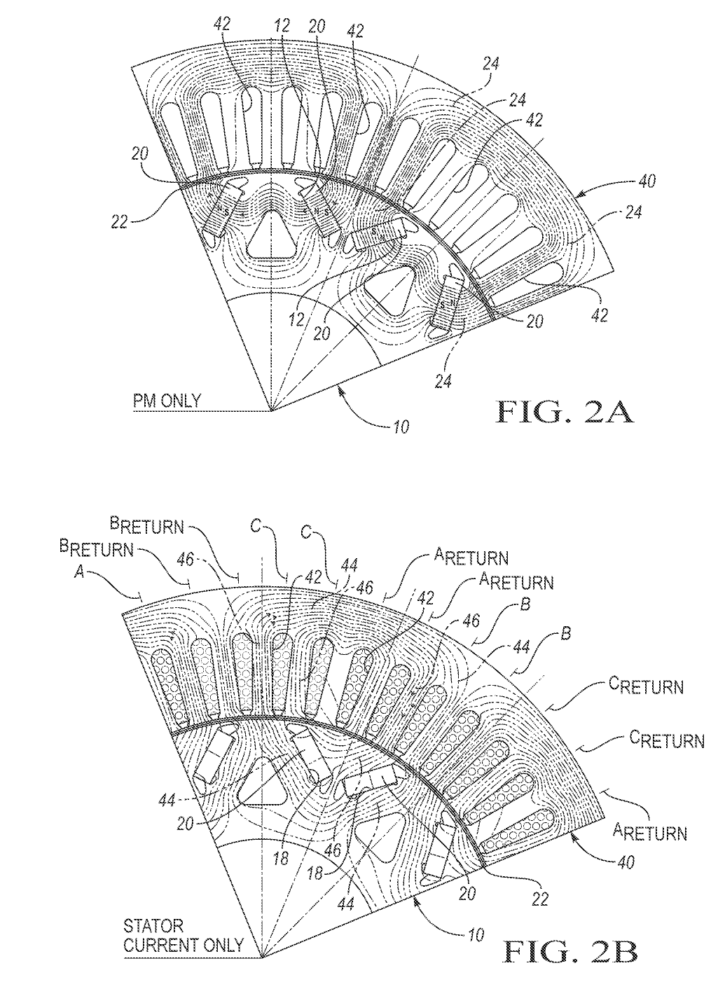

Referring now to FIG. 2A, a portion of the section 10 is shown within a stator 40. The section 10 defines pockets or cavities 12 adapted to hold permanent magnets 20. The permanent magnets 20 are arranged in a V-shape, collectively forming poles. Flux lines 24 emanating from the permanent magnets 20 are shown. The flux lines 24 may permeate through the section 10 and across the airgap 22 into the stator 40. In general, magnetic flux has greater field density when the flux lines 24 are closer together. Redirection of the flux lines 24 may cause an increased magnetic field density in certain locations as shown in FIG. 2A. The stator 40 has windings 42 that are not energized.

Referring to FIG. 2B, a section of the section 10 is shown within the stator 40. The stator 40 may have windings 42 that are energized. Flux lines 44 may emanate from the windings 42. The flux lines 44 may permeate through the stator 40 and across the airgap 22 into the section 10. A three-phase motor may have windings A, B, and C. The flux lines 44 and flux lines 24 may at least partially interact at position 46 in known fashion to produce torque.

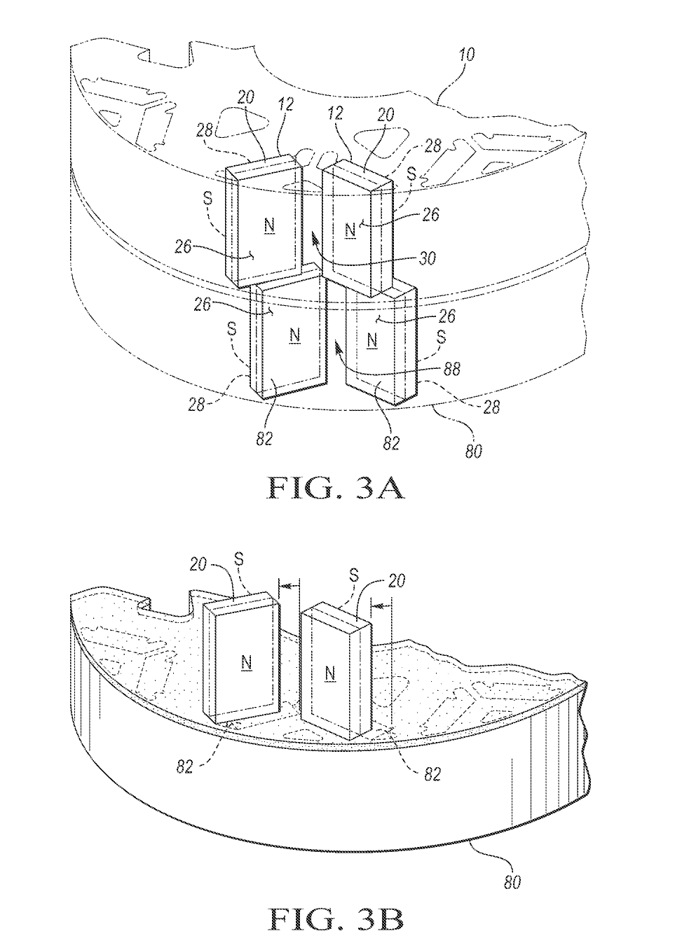

Referring to FIG. 3A, a skewed, adjacent pair of lamination sections 10, 80 may have cavities 12, 84 adapted to hold permanent magnets 20, 82. The permanent magnets 20, 82 may be magnetized such that the north poles 26 face a radially outward direction with respect to the rotor. The permanent magnets 20, 82 may be magnetized such that the south pole 28 faces a generally inward direction. The permanent magnets 20, 82 may be arranged to form magnetic poles 30, 88. The magnetic poles 30, 88 may be skewed or staggered. A layer 86 having low magnetic permeability may be disposed between the lamination sections 10, 80. The layer's outer diameter may fit flush with the outer diameter of the sections 10, 80 or the layer's outer diameter may stop short of the outer diameter of the sections 10, 80. As shown in FIG. 3B, the permanent magnets 20 may be offset from the permanent magnets 82 to form a skewed rotor. A layer 86 having low magnetic permeability may be placed between the sections 10, 80.

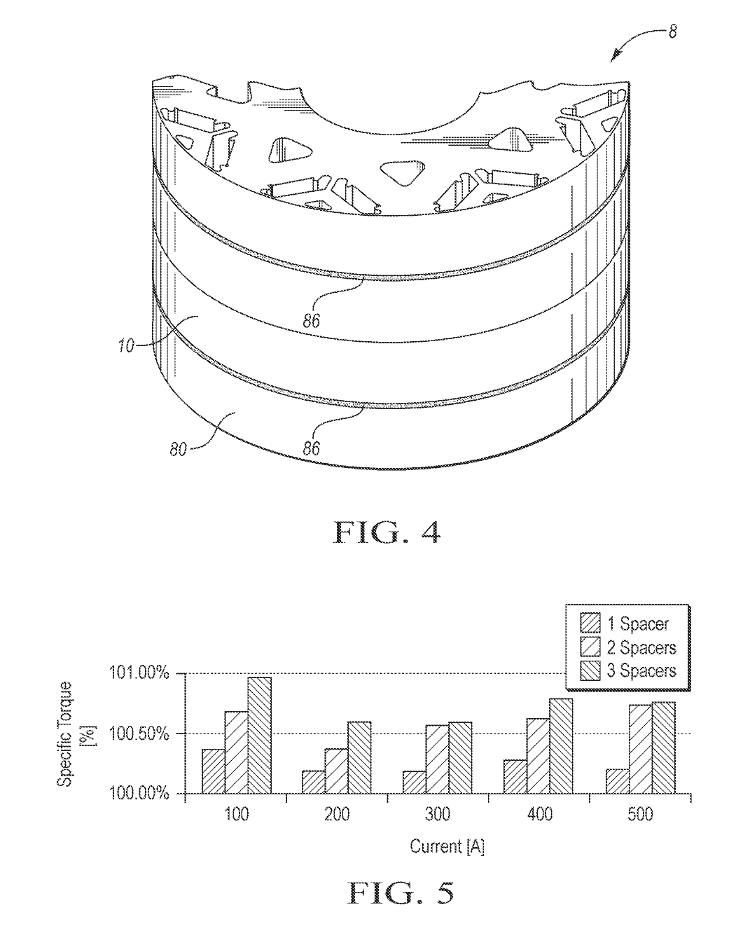

Referring to FIG. 4, a skewed rotor 8 may have a plurality of lamination sections 10, 80. The plurality of lamination sections may be skewed in an ABBA pattern, wherein the letters reference the sections relative skewing and position in the rotor 8 stack. Layers 86 may be interposed between the adjacent AB lamination sections.

Referring to FIG. 6, a possible relationship is depicted between the specific torque output of the electric machine, the thickness of the layers, and the applied current. A layer may have the same thickness as the airgap between the rotor and the stator. Typically, an airgap distance for an electric machine may range between 0.5 mm to 1.0 mm. For example, an airgap may have a thickness of 0.7 mm. A layer having low magnetic permeability may be 0.85 mm. As shown in FIG. 6, the thickness of layers having low magnetic permeability may be increased or decreased to benefit a particular electric machine. A rotor with a reluctant layer having a thickness of 1.7 mm may generate higher torque than a rotor without a reluctant layer.

The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. An electric machine comprising:
a plurality of sections each formed from one or more laminations and each having permanent magnets arranged therein to form magnetic poles, wherein the sections are stacked to form a rotor;
a diamagnetic or paramagnetic layer interposed between each adjacent pair of the sections that has skewed magnetic poles; and
a stator surrounding the rotor.

2. The electric machine of claim 1, wherein a thickness of each of the layers is based on an airgap distance between the rotor and stator.

3. The electric machine of claim 2, wherein the thickness of each of the layers is at least twice an airgap distance between the rotor and stator.

4. The electric machine of claim 3, wherein the thickness of each of the layers is less than four times an airgap distance between the rotor and stator.

5. The electric machine of claim 1, wherein the layers are polytetrafluoroethylene.

6. The electric machine of claim 1, wherein the sections are electrical steel.

7. An electric machine comprising:
a rotor including a plurality of sections each formed from one or more laminations and each containing permanent magnets arranged in a V-shape position;
a diamagnetic or paramagnetic layer interposed between an adjacent pair of the sections having staggered magnetic poles; and
a stator surrounding the rotor.

8. The electric machine of claim 7, wherein a thickness of the layer is at least twice an airgap distance between the rotor and the stator.

9. The electric machine of claim 8, wherein the thickness of the layer is less than four times the airgap distance between the rotor and the stator.

10. The electric machine of claim 7, wherein a thickness of the layer is less than 2 mm.

11. The electric machine of claim 7, wherein the layer is polytetrafluoroethylene.

12. An electric machine comprising:
a plurality of sections, having a magnetic permeability greater than 100 relative to a vacuum, and reluctant layers, having a magnetic permeability of less than two relative to a vacuum, stacked to form a rotor such that an adjacent pair of the sections having staggered magnetic poles has one of the reluctant layers disposed therebetween, wherein the one of the reluctant layers is configured to impede magnetic flux leakage between permanent magnets of the adjacent pair of the sections.

13. The electric machine of claim 12 further comprising a stator surrounding the rotor.

14. The electric machine of claim 13, wherein a thickness of each of the reluctant layers is at least twice an airgap distance between the rotor and the stator.

15. The electric machine of claim 14, wherein the thickness of each of the reluctant layers is less than four times the airgap distance between the rotor and the stator.

16. The electric machine of claim 12, wherein a thickness of each of the reluctant layers is less than 2 mm.

17. The electric machine of claim 12, wherein at least one of the reluctant layers is polytetrafluoroethylene.
